(19) United States
(12) Patent Application Publication
(10) Pub. No.: US 2003/0116076 A1
(43) Pub. Date: Jun. 26, 2003

(54) Car spinning display

(76) Inventor: Fabio Hoyos, Hollywood, FL (US)

Correspondence Address: Robert E. Pershes, Esq., Becker & Poliakoff, P.A., 3111 Stirling Road, Fort Lauderdale, FL, 33312, US

(21) Appl. No.: 10/033,811

(22) Filed: Dec. 20, 2001

(51) Int. Cl. B60Q 11/00

(52) U.S. Cl. 116/28 R

(57) ABSTRACT

A novel vehicle flag system is provided. The vehicle flag systems allows an automobile owner to display one or more flags, logos or insignias simultaneously.

### FIELD OF THE INVENTION

This invention pertains to automobile displays.

### BACKGROUND

During the past few months, the display of the American flag from cars and trucks has increased exponentially. In Baltimore, following the victory of the Ravens at the SuperBowl, the display of flags containing the Ravens' logo from cars and trucks was almost a requirement to live in the area. As people spend more time commuting, the need to personalize their cars increases. Even advertisers are catching on to the trend, in that there are several cities that currently utilize billboard vehicles for advertising purposes.

Many patents have issued for means to attach flags to cars over the past ten years. For instance, U.S. Pat. No. 5,233,938 to Lalo provides a window mount having a U-shaped clip that sits over the top edge of the vehicle window. A normal rectangular flag is attached to the novel clip.

U.S. Pat. No. 6,010,107 to Goldfarb improves upon the prior art by utilizing an attachment means that allows the display of two different flags. Again, no variation is provided to the actual flag.

U.S. Pat. No. 3,818629 to Davidson provides a different display, in the form of a wind-driven impeller or rotor. The preferred embodiment attaches a pull-tab beverage container to the center of the impeller wheel. The ability to decorate your car with your favorite beverage has not appeared to catch on with society.

### SUMMARY OF THE INVENTION

The present invention provides a means for displaying loyalty to more than one country or sports team or combining the two simultaneously. In addition, a person could decorate their car with several advertisements via the current invention.

The present invention reveals a vehicle display system that provides many planes on which to display flags or other insignia. The planes spin around the flag mast as a result of wind or momentum, thereby displaying any number of pictures that a person desires.

### BRIEF DESCRIPTION OF THE DRAWINGS

Referring now to the drawings, which provides one of the various possible exemplary embodiments of the invention as shown.

FIG. 1 is a perspective view of the vehicle display system utilizing four planes.

FIG. 2 is a front view of the same vehicle display system.

### DETAILED DESCRIPTION

The present vehicle display system allows a person to display many commercial signs, pictures, logos, flags or designs on their vehicle. In the preferred embodiment, the vehicle display system is comprised of four planes. The American flag is placed on one side of each of the four planes. The Ravens logo is placed on the other side of each plane. As the vehicle is driven, the planes rapidly circle the mast, providing the visual impression of the American flag and the Ravens logo. Obviously, any flag, logo, design, advertisement, symbol can be used.

In another embodiment, a motion picture effect is displayed. Each plane contains a picture of something in motion, such as a stick figure swinging a bat, with each plane subsequent displaying the next motion of the sequence. As the planes circle the flag mast, the stick figure actually appears to swing the bat0.

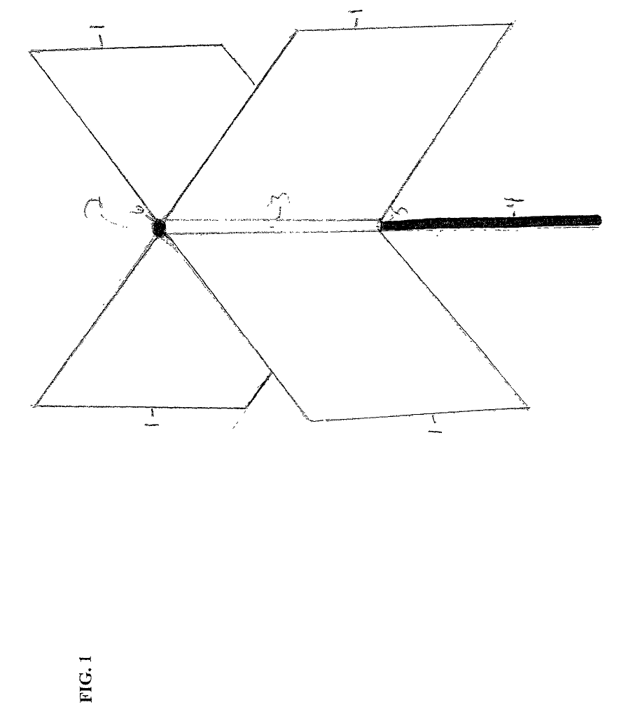

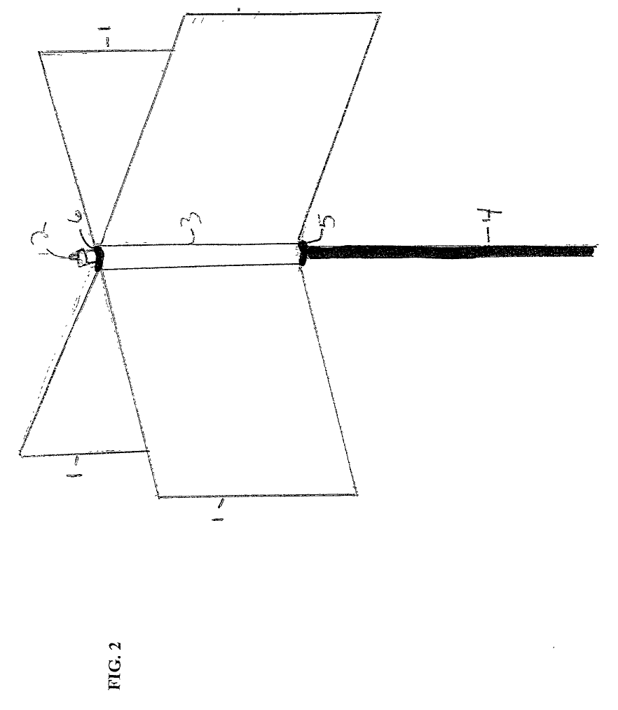

FIGS. 1 and 2 provide an example of the preferred embodiment of the invention. Four planes 1 are utilized in this vehicle display system. The number of planes used is not critical and fewer or more planes may be used without detracting from the spirit of the invention. The planes may be in any shape; including, but not limited to, square, rectangular, triangular, pentagonal, etc. Preferably, the planes' shapes include an aerodynamic function to facilitate spinning. This function could include a bend in the plane or one plane being larger than the others. The planes 1 extend radially from the tube system 2. The planes are made of material that stands up to high wind and weather, such as, but not limited to, metal, plastic or fiberglass. The logo, insignia or flag utilized can be a sticker applied to the plane, an etching on the plane or a drawing slid between clear plates of the plane.

In the preferred embodiment displayed by FIGS. 1 and 2, a tube system 2 is utilized as the means for the four planes 1 to radially encircle the mast. In this tube system 2, each of the planes 1 is attached to the tube 3 that encircles the mast 4. The tube 3 rests between the mid resting point 5 and upper restraint point 6. Preferably, one of the four planes is larger than the other three to facilitate spinning in this embodiment.

In another embodiment, the means for the four planes to radially encircle the mast comprises an upper disc and a lower disc to which said two or more vertical planes are attached. In this system, the discs act similar to the tube discussed above, without the bulk. Preferably, the upper disc is connected to the top of the planes and the lower disc is connected to the bottom of the planes. However, one of ordinary skill in the art could connect the upper disc to a spot below the top of the planes. Similarly, the lower disc could be connected to a spot above the bottom of the planes. The lower disc rests on the mid resting point and the upper disc is located below the upper restraint point.

The mid resting point is not required to be in the middle of the mast. The only requirement is that the mid resting point is below the upper restraint point. In addition, the upper restraint point is not required to be at the top of the mast. It is within the skill of the art to place two or more display systems on one mast. In this scenario, the upper restraint point may be identical to the mid resting point for the second display system. Or, the upper restraint point may be directly adjacent to the mid resting point for the second display system. One skilled in the art can vary the distance between these two points to best suit the planes they hope to utilize. Obviously, larger planes will require more of a distance between the lower mid resting point and upper restraint point.

In an alternate embodiment, the spinning effect can be achieved by a split mast mechanism. In this embodiment, the planes are attached directly to the top portion of a split mast. The top portion of the split mast is connected to the bottom portion of the split mast via a pin or bearing connection that allows the top portion to turn while the bottom portion remains stationary.

The means for attaching the system to the vehicle is not included in FIGS. 1 or 2. However, any of the attachment systems utilized in the previous art will work, including suction cups, brackets, clamps, fasteners, etc.. For example, the window mount utilized in U.S. Pat. No. 5,233,938 to Lalo would perform this function well. Or, the flag holding device of U.S. Pat. No. 6,010,107 to Goldfarb would also work. Goldfarb presents a wonderful compilation of flag holding devices, in the Background of the Invention, all of which could be utilized with the instant invention.

Finally, the vehicle display system can be attached to any vehicle; including, but not limited to, cars, trucks, vans, buses, bikes (both pedal-bikes and motor bikes, including motorcycles, tricycles, tandem bikes, etc.), boats, jet skis, trains, and planes.

I claim:

1. A vehicle display system comprising
a. means for attaching the system to a vehicle;
b. a mast comprising a mid resting point and an upper restraint point;
c. means for two or more vertical planes to radially encircle said mast.

2. The vehicle display system of claim 1 wherein said means for two or more vertical planes to radially encircle said mast comprises a tube system to which said two or more vertical planes are attached.

3. The vehicle display system of claim 1 wherein said means for two or more vertical planes to radially encircle said mast comprises an upper disc and a lower disc to which said two or more vertical planes are attached.

4. The vehicle display system of claim 1 wherein said two or more vertical planes encircle said mast between said mid resting point and said upper restraint point.

5. The vehicle display system of claim 1 wherein said mid resting point provides a bottom for said two or more vertical planes.

6. The vehicle display system of claim 1 wherein said upper restraint point prevents said two or more vertical planes from detaching from said vehicle display system.

7. The vehicle display system of claim 1 wherein four vertical planes encircle said mast.

8. A vehicle display system comprising
a. a window clip to attach the system to a vehicle;
b. a mast comprising a mid resting point and an upper restraint point and extending from the window clip;
c. means for two or more vertical planes to radially encircle said mast.

9. The vehicle display system of claim 8 wherein said means for two or more vertical planes to radially encircle said mast comprises a tube system to which said two or more vertical planes are attached.

10. The vehicle display system of claim 8 wherein said means for two or more vertical planes to radially encircle said mast comprises an upper disc and a lower disc to which said two or more vertical planes are attached.

11. The vehicle display system of claim 8 wherein said two or more vertical planes encircle said mast between said mid resting point and said upper restraint point.

12. The vehicle display system of claim 8 wherein said mid resting point provides a bottom for said two or more vertical planes.

13. The vehicle display system of claim 8 wherein said upper restraint point prevents said two or more vertical planes from detaching from said vehicle display system.

14. The vehicle display system of claim 8 wherein four vertical planes encircle said mast.

15. A vehicle display system comprising
a. a window clip to attach the system to a vehicle;
b. a mast comprising a mid resting point and an upper restraint point and extending from the window clip;
c. a tube system that encircles said mast to which two or more vertical planes are attached.

16. The vehicle display system of claim 15 wherein said two or more vertical planes encircle said mast between said mid resting point and said upper restraint point.

17. The vehicle display system of claim 15 wherein said mid resting point provides a bottom for said two or more vertical planes.

18. The vehicle display system of claim 15 wherein said upper restraint point prevents said tube system from detaching from said vehicle display system.

19. The vehicle display system of claim 15 wherein four vertical planes encircle said mast.

20. A vehicle display system comprising
a. a window clip to attach the system to a vehicle;
b. a mast comprising a mid resting point and an upper restraint point and extending from the window clip;
c. an upper disc and a lower disc that encircle said mast to which two or more vertical planes are attached.

21. The vehicle display system of claim 20 wherein said two or more vertical planes encircle said mast between said mid resting point and said upper restraint point.

22. The vehicle display system of claim 20 wherein said mid resting point provides a bottom for said lower disc.

23. The vehicle display system of claim 20 wherein said upper restraint point prevents said upper disc, said two or more vertical planes and said lower disc from detaching from said vehicle display system.

24. The vehicle display system of claim 20 wherein four vertical planes encircle said mast.

25. A vehicle display system comprising
a. means for attaching the system to a vehicle and
b. a split mast comprising
i. a top portion of the mast comprising the mast connected to two or more radially disposed vertical planes and
ii. a bottom portion of the mast,
wherein the top portion of the mast is connected to the bottom portion of the mast by a spinning mechanism that enables the radially disposed vertical planes to spin.

26. The vehicle display system of claim 25 wherein four vertical planes encircle said mast.
